(19) United States
(12) Patent Application Publication
(10) Pub. No.: US 2005/0223204 A1
(43) Pub. Date: Oct. 6, 2005

(54) Data processing apparatus adopting pipeline processing system and data processing method used in the same

(75) Inventor: Takumi Kato, Kanagawa (JP)

Correspondence Address: YOUNG & THOMPSON, 745 SOUTH 23RD STREET, 2ND FLOOR, ARLINGTON, VA, 22202, US

(73) Assignee: NEC ELECTRONICS CORPORATION, KANAGAWA (JP)

(21) Appl. No.: 11/092,705

(22) Filed: Mar. 30, 2005

(30) Foreign Application Priority Data
Mar. 30, 2004 (JP) 2004-099111

(51) Int. Cl. G06F 15/00

(52) U.S. Cl. 712/241

(57) ABSTRACT

A data processing apparatus adopting a pipeline processing system, includes an instruction memory which store instruction packets; and a processing unit configured to execute the instruction packets sequentially in a pipeline manner. The processing unit includes an instruction queue and a loop speed-up circuit. The instruction packets stored in the instruction queue are executed sequentially by the processing unit. The loop speed-up circuit stores the instruction packets read out from the instruction memory into the instruction queue sequentially, holds the instruction packet containing a loop start address for a loop process, and outputs the held instruction packet to the instruction queue, when a loop process end is detected and the loop process is not circulated for a predetermined number of times.

### BACKGROUND OF THE INVENTION

1. Field of the Invention

The present invention relates to a data processing apparatus adopting a pipeline processing system, in which a plurality of processes are executed in parallel, and a data processing method used in the same.

2. Description of the Related Art

In order to speed up processing, a “pipeline processing system” has been adopted in a data processing apparatus to execute a plurality of instructions in parallel while shifting slightly in timing.

In the pipeline processing, the processing speed itself for executing the instructions is not speeded up. However, the instructions are executed in parallel (in the pipeline processing, the execution step is generally referred to as a “stage”), which contributes an increase of the performance for each unit time. As a result, the processing speed can be improved. If a job is enough, a speed improvement ratio in the pipeline processing is equal with the number of stages.

In general, the data processing apparatus reads an instruction packet for instructions to be executed from the instruction memory, and stores the read instruction packet in an instruction queue. Then, the instructions of the instruction packet are read out from the instruction queue and are executed. The operation to read the instruction packet from the instruction memory and to store them in the instruction queue previously is referred to as a “preceding read”

In the data processing apparatus adopting a pipeline processing system, when an instruction group of a same process is repeated, that is, when loop processing is executed, the speed improvement ratio reduces sometimes.

Next, the pipeline processing in a conventional data processing apparatus at a loop back will be described. FIG. 1 shows a configuration of the conventional data processing apparatus. A processor 500 has an instruction queue 506. The processor 500 reads an instruction packet from an instruction memory 600 into the instruction queue 506. The processor 500 determines whether an instruction to be executed is a loop start instruction, that is, whether the loop start instruction has been issued. Also, the processor 500 determines whether the processing should be looped out from a loop, during the execution of the loop instruction.

FIG. 2 shows an operation of the data processing apparatus at the loop back, that is, an operation when the processing returns to the head of the loop since the loop is not circulated for the predetermined number of times. Here, it is supposed that the processor 500 requires time for two stages to read the instruction packet from the instruction memory 600. As shown in FIG. 3, in the loop processing, instructions from a first instruction (LT1) to a last instruction (LL) are repeated for the predetermined number of times. In the example shown in FIG. 3, a loop end (LE) is detected in the instruction immediately before the last instruction (LL) of the loop. In response to the detection of the loop end, it is determined whether the loop has been repeated for the predetermined number of times. When it is determined that the loop has not repeated for the predetermined number of times, the processing returns to the first instruction after the execution of the last instruction of the loop, that is the loop back is carried out. When it is determined that the loop has been repeated for the predetermined number of times, the processing loops out after execution of the last instruction. In this case, the processor 500 executes the instructions in the order from LE to LL, LT1, LT2, . . . at the loop back.

However, as shown in FIG. 2, the processor 500 has already started to read the instruction packet at the detection of the address of the loop end. Such an instruction packet should not be originally executed, which is read in a cycle in which the loop end is detected. That is, the instruction packet, which is read in the cycle at the detection of the loop end, is read from an invalid memory address. Therefore, in order to execute the instruction (LT1) after the loop back, it is necessary for the processor 500 to read an instruction packet from the instruction memory 600 into the instruction queue 506. In other word, the reading of the instruction packet for the loop processing is executed in the following cycle to the cycle in which the loop end is detected. Therefore, an unuseful cycle shown in FIG. 2 by INVALID is generated between the last instruction of the loop processing and the first instruction of the loop processing. As a result, in the data processing apparatus adopting the pipeline processing system of the preceding read, a delay (latency) is generated at the loop back in the execution of the loop processing, which causes an obstruction of speeding up of the processing.

Japanese Laid Open Patent Application (JP-A-Showa 63-314644) discloses a data processing apparatus for high-speed execution of a loop instruction as a first conventional example. In the first conventional example, when an additional data to a preceding instruction indicates to store an instruction group for a loop in a loop instruction queue, the instruction group for the loop is stored in a loop instruction queue.

However, the first conventional example is aimed to speed up the execution of the loop instruction by reducing the read time of the instruction group for the loop and any consideration is not made to the latency at the loop back. In addition, the first conventional example stores all the instructions of the instruction group for the loop in the loop instruction queue for the high-speed execution of the loop. Therefore, the size of the hardware increases. Especially, in the processing of multi-loop, the amount of the data to be stored in the loop instruction queue becomes huge.

Thus, the conventional data processing apparatus of the pipeline processing system cannot prevent the delay at the loop back of the loop processing.

### SUMMARY OF THE INVENTION

In an aspect of the present invention, a data processing apparatus adopting a pipeline processing system, includes an instruction memory which store instruction packets; and a processing unit configured to execute the instruction packets sequentially in a pipeline manner. The processing unit includes an instruction queue and a loop speed-up circuit. The instruction packets stored in the instruction queue are executed sequentially by the processing unit. The loop speed-up circuit stores the instruction packets read out from the instruction memory into the instruction queue sequentially, holds the instruction packet containing a loop start address for a loop process, and outputs the held instruction packet to the instruction queue, when a loop process end is detected and the loop process is not circulated for a predetermined number of times.

Here, the loop speed-up circuit may include a loop instruction queue group; a loop queue flag configured to indicate whether the loop queue flag is valid or invalid; and a selector. The processing-unit determines whether the instruction packet to be executed is a loop start instruction for the loop process, copies the instruction packet containing the loop start address from the instruction queue into the loop instruction queue group when determining that the instruction packet to be executed is the loop start instruction, and sets the loop queue flag to a valid state.

In this case, the processing unit may control the selector to select and output the instruction packet stored in the loop instruction queue group to the instruction queue, when the loop process end is detected and the loop process is not circulated for a predetermined number of times.

Also, the processing unit may control the selector to select and output the instruction packet read from the instruction memory to the instruction queue, when the loop process end is not detected or the loop process is circulated for a predetermined number of times.

Also, the processing unit may control the selector to select and output the instruction packet read from the instruction memory to the instruction queue, when the instruction packet to be executed is an instruction packet for looping out from the loop process.

Also, the processing unit may set the loop queue flag to an invalid state, when the instruction packet to be executed is an instruction packet for looping out from the loop process or the loop process is circulated for a predetermined number of times. In this case, the processing unit may control the selector to select and output the instruction packet read from the instruction memory to the instruction queue, when the loop queue flag is in the invalid stage, and may control the selector to select and output the instruction packet stored in the loop instruction queue group to the instruction queue, when the loop process end is detected, the loop process is not circulated for a predetermined number of times, and the loop queue flag is in the valid stage.

Also, the loop instruction queue group may include loop instruction queues of a number less by one than a number of stages necessary to read the instruction packet from the instruction memory into the instruction queue. In this case, the processing unit may control the selector to select and output the stored instruction packet from each of the loop instruction queues of the loop instruction queue group to the instruction queue sequentially.

In another aspect of the present invention, a data processing method using a pipeline processing system, is achieved by reading instruction packets from an instruction memory into instruction queue through a selector sequentially; by determining whether the instruction packet to be executed is a loop start instruction for a loop process; by copying the instruction packet containing a loop start address from the instruction queue into the loop instruction queue when determining that the instruction packet to be executed is the loop start instruction; by setting the loop queue flag to a valid state; and by executing the instruction packets stored in the instruction queue sequentially.

Here, the data processing method may be achieved by further determining whether the instruction packet to be executed is an instruction packet for looping out; by setting the loop queue flag to an invalid state, when determining that the instruction packet is the instruction packet for the looping out; and by carrying out the read of the instruction packet from the instruction memory into the instruction queue.

Also, the data processing method may be achieved by further determining whether the loop process reaches a loop end, when determining that the instruction packet is not the instruction packet for the looping out; and by carrying out the read of the instruction packet from the instruction memory into the instruction queue, when determining that the loop process does not reach the loop end.

Also, the data processing method may be achieved by further determining whether the loop process is circulated for a predetermined number of times by the loop start instruction, when determining that the loop process reaches the loop end; by setting the loop queue flag to the invalid state, when determining that the loop process is circulated for the predetermined number of times; and by carrying out the read of the instruction packet from the instruction memory into the instruction queue.

Also, the data processing method may be achieved by further checking whether the loop queue flag is in the valid state, when determining that the loop process is circulated for the predetermined number of times; and by carrying out the read of the instruction packet from the instruction memory into the instruction queue, when determining the loop queue flag is not in the valid state.

Also, the data processing method may be achieved by further reading the instruction packet stored into the loop instruction queue when determining that the loop queue flag is in the valid state.

Also, the loop instruction queue group may include loop instruction queues of a number less by one than a number of stages necessary to read the instruction packet from the instruction memory into the instruction queue.

### BRIEF DESCRIPTION OF THE DRAWINGS

FIG. 1 is a block diagram showing a configuration of a conventional data processing apparatus;

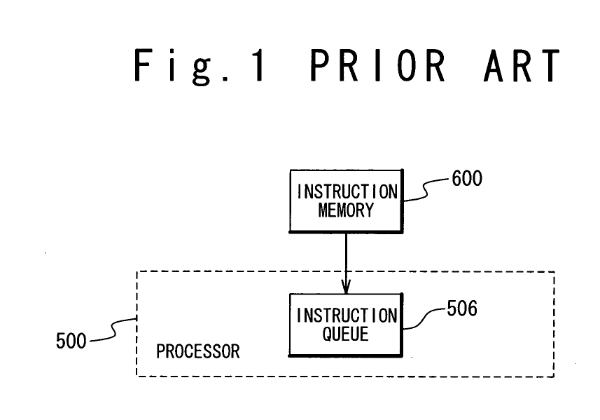

FIG. 2 is a sequence diagram showing an operation of the conventional data processing apparatus at a loop back;

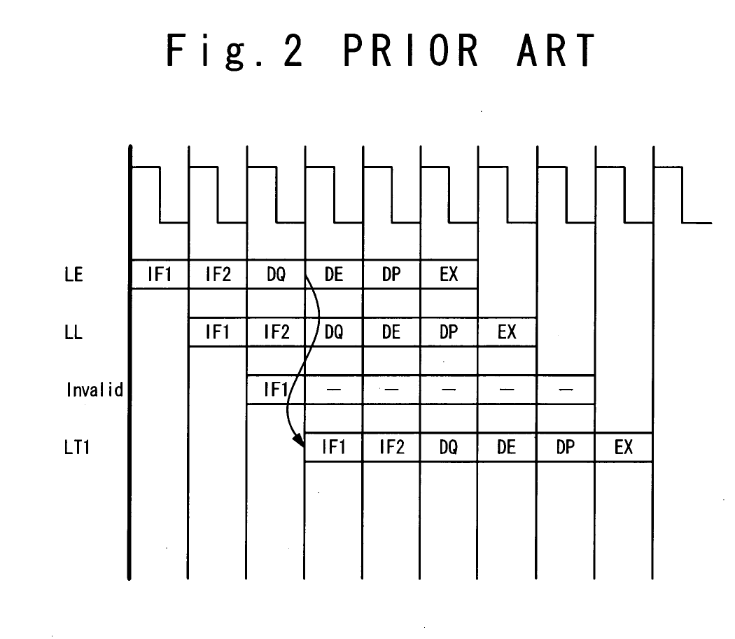

FIG. 3 is a diagram showing instructions from a first instruction (LT1) to a last instruction (LL) to be repeated for loop processing;

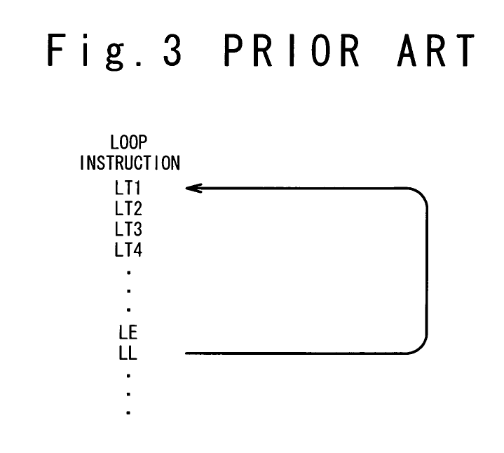

FIG. 4 is a block diagram showing a configuration of a data processing apparatus adopting a pipeline processing system according to a first embodiment of the present invention;

FIG. 5 is a block diagram showing a configuration of the data processing apparatus in the first embodiment more in detail;

FIG. 6 is a flowchart showing an operation of the data processing apparatus in the first embodiment;

FIG. 7 is a sequence diagram showing an operation of the data processing apparatus in the first embodiment at a loop back;

FIG. 8 is a block diagram showing a configuration of the data processing apparatus according to a second embodiment of the present invention; and

FIG. 9 is a sequence diagram showing an operation of the data processing apparatus in the second embodiment at the loop back.

### DESCRIPTION OF THE PREFERRED EMBODIMENTS

Hereinafter, a data processing apparatus of the present invention will be described with reference to the attached drawings.

### First Embodiment

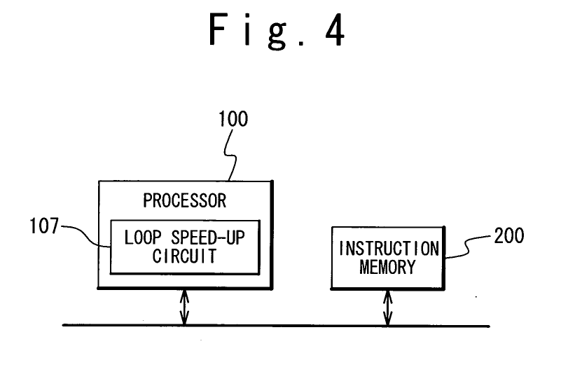

FIG. 4 shows a configuration of the data processing apparatus adopting a pipeline processing system according to the first embodiment of the present invention. As shown in FIG. 4, the data processing apparatus in the first embodiment includes a processor 100 and an instruction memory 200, which are connected through a bus. The processor 100 has a loop speed-up circuit 107. The processor 100 reads an instruction packet into the instruction queue 106 from the instruction memory 200. The processor 100 determines whether an instruction to be executed is a loop start instruction, that is, determines whether a loop instruction has been issued. Also, the processor 100 determines whether the processing should be looped out during the execution of the loop instruction.

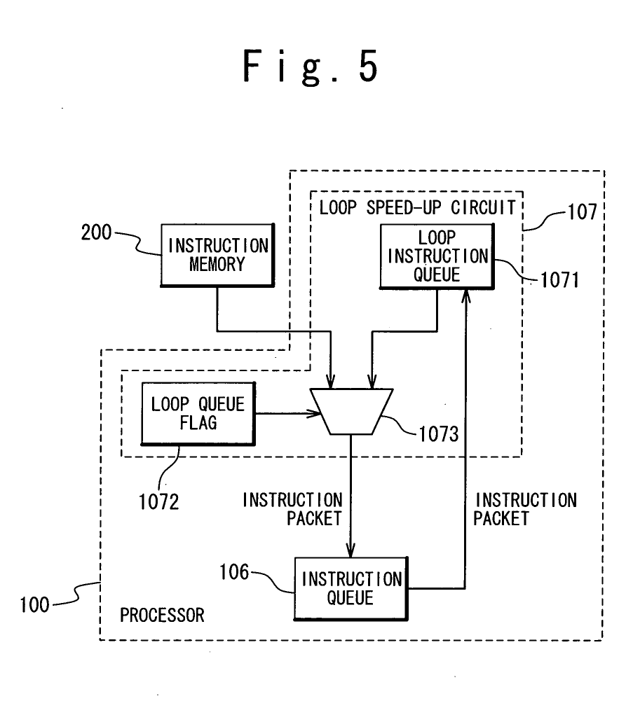

FIG. 5 shows a configuration of the data processing apparatus in the first embodiment more in detail. The processor 100 has an instruction queue 106 and the loop speed-up circuit 107. The loop speed-up circuit 107 includes a loop instruction queue 1071, a loop queue flag 1072 and a selector 1073. The loop queue flag 1072 indicates whether the loop instruction queue 1071 is valid or not. The selector 1073 selects one of the instruction packet read from the instruction memory 200 and the instruction packet read from the loop instruction queue 1071 under the control by the processor 100. When determining that the loop instruction has been issued, the processor 100 reads and stores the instruction packet containing a loop start address from the instruction queue 106 into the loop instruction queue 1071.

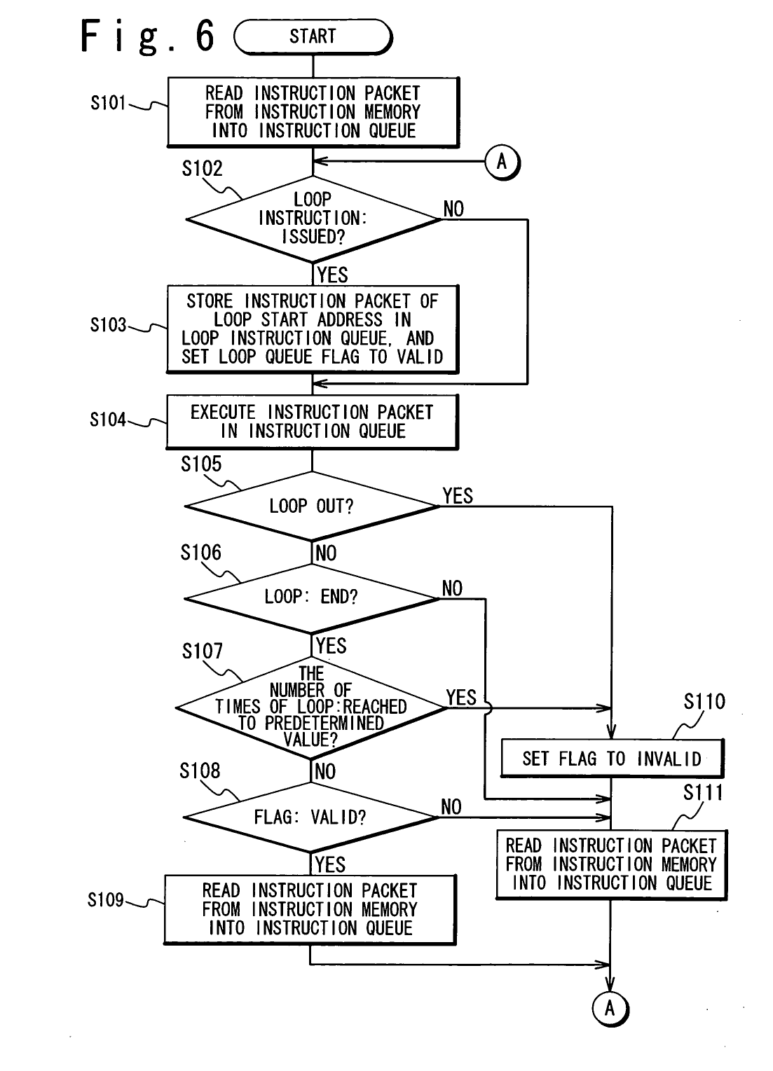

Next, an operation of the data processing apparatus in the first embodiment will be described below. FIG. 6 is a flowchart showing the operation of the data processing apparatus in the first embodiment. In an initial state, the selector 1073 selects the instruction memory 200 and the loop queue flag 1072 indicates an invalid state.

Until the loop instruction is issued, the processor 100 reads the instruction packets from the instruction memory 200 into the instruction queue 106, and executes the instruction packet read in the instruction queue 106 sequentially (Step S101, S102/No, S104, S105/No, S106/No, and S111).

When determining that the loop instruction has not been issued (Step S102/No), the processor 100 executes the instruction packet read in the instruction queue 106. On the other hand, when determining that a loop instruction has been issued (Step S102/Yes), the processor 100 reads and stores a first instruction packet for the loop processing from the instruction queue 106 into the loop instruction queue 1071. At the same time, the processor 100 sets the loop queue flag 1072 to a valid state (Step S103). Then, the processor 100 executes the instruction packet read in the instruction queue 106 (Step S104). In this case, the processor 100 determines whether the instruction to be executed is an instruction for looping out or looping hop (Step S105). When determining that the instruction is the instruction for looping out (Step S105/Yes), the processor 100 sets the loop queue flag 1072 to an invalid state (Step S110).

On the other hand, when determining that the instruction packet to be executed by the processor 100 is not the instruction of looping out (Step S105/No), the processor 100 determines whether the processing reached a loop end (Step S106). When determining that the processing does not reach the loop end (Step S106/No), the processor 100 reads the instruction packet from the instruction memory 200 into the instruction queue 106 (Step S111). When determining that the processing reaches the loop end (Step S106/Yes), the processor 100 determines whether the loop is circulated for the predetermined number of times by the loop instruction. Subsequently, when determining that the loop is circulated for the predetermined number of times (Step S107), the processor 100 sets the loop queue flag 1072 to the invalid state (Step S110). On the other hand, when determining that the loop is circulated for the predetermined number of times (Step S107/No), the processor 100 checks whether the loop queue flag 1072 is valid or not (Step S108).

When the loop queue flag 1072 is valid (Step S108/Yes), the processor 100 controls the selector 1073 to select the loop instruction queue 1071, and then reads the instruction packet stored into the loop instruction queue 1061, that is, the instruction packet containing the loop start address into the instruction queue 106 (Step S109). After the first instruction packet is read into the instruction queue 106 from the loop instruction queue 1071, the processor 100 controls the selector 1073 to select the instruction memory 200. On the other hand, when the loop queue flag 1072 is invalid (Step S108/No), the processor 100 reads the instruction packet into the instruction queue 106 from the instruction memory 200 (step S111).

Thereafter, the processing returns to the step S102, and the same steps as the above-mentioned are repeated until the processing is ended.

In the first embodiment, the processor 100 reads the instruction packet stored in the loop instruction queue 1071 into the instruction queue 106 in the following cycle to a cycle in which the loop end is detected. Therefore, it is possible to read the instruction packet earlier by one cycle, compared with a case of reading from the instruction memory 200 in the following cycle. As a result, the latency cannot be generated at the loop back.

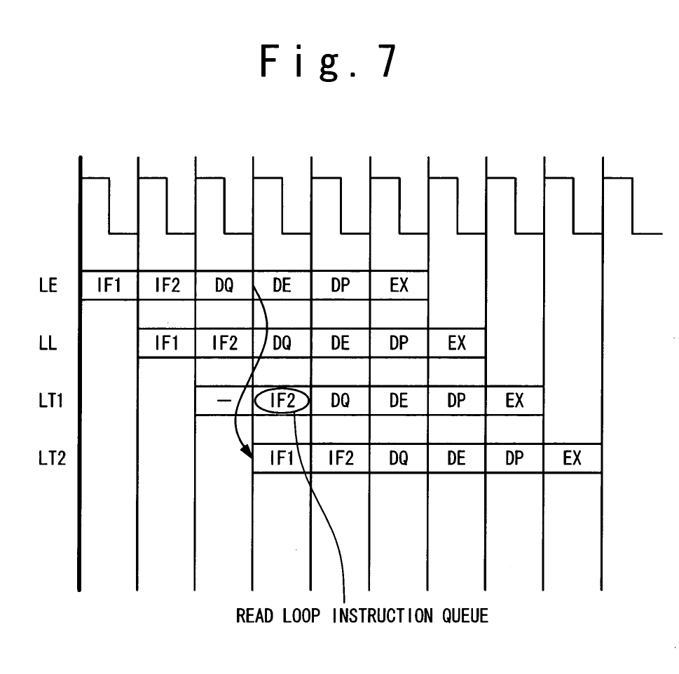

FIG. 7 shows an operation of the data processing apparatus in the first embodiment at a loop back. As shown in FIG. 7, IF1 and IF2 indicate that it takes time for two stages for the processor 100 to read the instruction packet from the instruction memory 200 into the instruction queue 106. Also, DQ indicates a stage in which the instruction packet is allocated, and DE indicates a stage in which the processor 100 decodes the instruction. DP indicates a stage in which the processor 100 changes or updates a data pointer, and EX indicates a stage in which the processor 100 executes the instruction.

The instruction packet is executed in the order from LE to LL, LT1, LT2 . . . at the loop back. In this example, time for two stages is needed for reading the instruction packet. Therefore, the reading of the instruction packet different from the instruction packet to be read at the stage LT1 has been started at the detection of the loop end. However, in the present invention, the processor 100 can read the instruction packet to be read at the stage LT1 from the loop instruction queue 1071 at the detection of the loop end. Therefore, the correct instruction packet can be read for the stage LT1 at the loop end without generating any latency.

In case of execution of the loop instruction, the first instruction packet for the loop processing is copied from the instruction queue 106 into the loop instruction queue 107 in the following stage to the stage in which the stage EX of the instruction packet for the loop instruction is ended. Also, the loop queue flag 1072 is set to the valid state. Also, the detection of the loop end is carried out based on an instruction immediately previous to the last instruction for the loop processing by the processor 100. Therefore, the processor 100 can read the first instruction packet for the loop processing from the loop instruction queue 106 in the following cycle to the cycle in which the loop end is detected.

In this way, in the data processing apparatus in the first embodiment, the processing is executed by reading the instruction packet stored in the loop instruction queue at the loop back. As a result, the latency is never caused at the loop back.

### Second Embodiment

Next, the data processing apparatus according to the second embodiment of the present invention will be described below. In the first embodiment, it takes time for two stages for the processor 100 to read the instruction packet from the instruction memory 200 to the instruction queue 106. In the second embodiment, a case will be described where it takes time for n stages to read the instruction packet from the instruction memory 200 to the instruction queue 106.

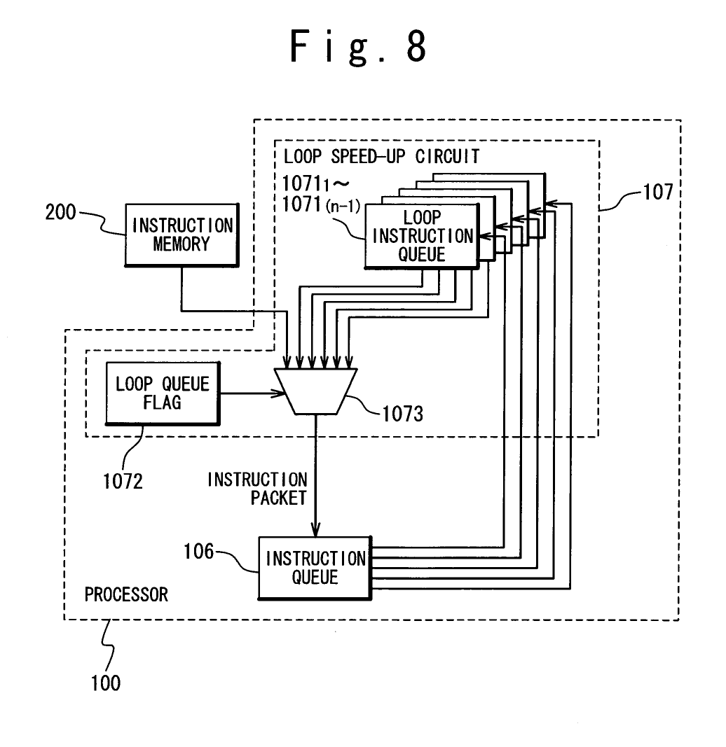

FIG. 8 shows a configuration of the data processing apparatus in the second embodiment of the present invention. The data processing apparatus has the same configuration as that of the first embodiment as whole. However, in the second embodiment, a processor 100 includes n-1 loop instruction queues 1071 (10711 to 1071 (n-1)).

Next, an operation of the data processing apparatus in the second embodiment will be described. An operation flow of the data processing apparatus in the second embodiment is almost same as that of the first embodiment. However, at the loop back, the processor 100 controls the selector 1073 to select the loop instruction queue 10711 such that an instruction packet LT1 is read out and then controls the selector 1073 to select the loop instruction queue 10712. Through this step, the processor 100 can read an instruction packet LT2 from the loop instruction queue 10712 at the following cycle. Similarly, the processor 100 controls the selector 1073 to sequentially select the loop instruction queues 10711 to 1071(n-1) for every stage such that the instruction packets are read out from the loop instruction queues 10711 to 1071(n-1) sequentially. Thus, at the loop back, the instruction packets LT1 as the first instruction packet for the loop processing to the instruction packet LT(n-1) as the n-1^{th} instruction packet are read from not the instruction memory from 200 but the loop instruction queues 10711 to 1071(n-1).

In this way, the processor 100 can read the instruction packets into the instruction queue 106 without specifying a memory address of the instruction memory 200. Therefore, the latency cannot be generated in the loop back.

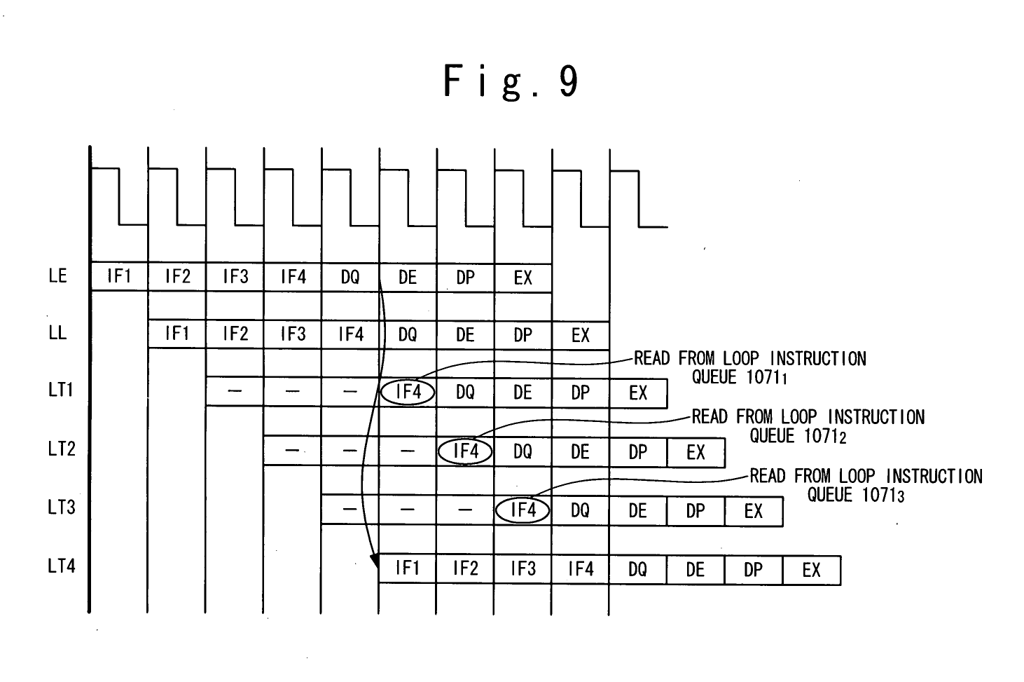

An operation of the data processing apparatus adopting the pipeline processing system in the second embodiment will be described below. In this example, the reading of the instruction packet from the instruction memory 200 needs the four stages of time. FIG. 9 shows the operation of the data processing apparatus in the second embodiment at the loop back. As shown in FIG. 9, IF1, IF2, IF3, and IF4 indicate that it takes four stages for the processor 100 to read the instruction packet to the instruction queue 106 from the instruction memory 200. Also, DQ indicates a stage in which the processor 100 allocates the instruction packet, and DE indicates a stage in which the processor 100 decodes the instruction. DP indicates a stage in which the processor 100 changes or updates a data pointer, and EX indicates a stage in which the processor 100 executes the instruction.

The instruction packet is executed in the order from LE to LL, LT1, LT2, LT3, LT4, . . . at the loop end. In this example, four stages of time are needed for reading. Therefore, the reading of the instruction packet different from the instruction packets to be read in LT1, LT2 and LT3 has been started at the detection of the loop end. However, in the present invention, the processor 100 can read the instruction packets to be read in LT1, LT2 and LT3 to the instruction queue 106 from the loop instruction queues 10711, 10712 and 10713, respectively. As a result, the instruction packets in LT1, LT2 and LT3 can be read without generating the latency at the loop end.

As mentioned above, the data processing apparatus in the second embodiment reads each of the n-1 instruction packets that are stored in the loop instruction queues at the loop back and executes the read instruction packets. Therefore, the latency is never generated at the loop back.

It should be noted that the above-mentioned embodiments are only one example of the present invention, and the present invention is not limited to these examples. For instance, each stage has had the same time length in the above-mentioned embodiments. However, the present invention can be applicable even if the time length is different in each stage. Thus, the present invention can be modified diversely.

As described above, in the present invention, the data processing apparatus determines whether the instruction packet is a loop start instruction, at the execution of the instruction packet. If the executed instruction packet is the loop start instruction, the instruction packets of the predetermined number are stored in the loop instruction queues from the first instruction of the instruction group for the loop processing. Then, the instruction packets stored in the loop instruction queues are read in the instruction queue sequentially when the loop end is detected. In this way, it is not necessary to read the first instruction packet for the loop processing from the instruction memory at the loop back. Therefore, the latency cannot be generated at the loop back. Thus, according to the present invention, it is possible to provide the data processing apparatus of a pipeline system with no latency at the loop back.

1. A data processing apparatus adopting a pipeline processing system, comprising:
an instruction memory which store instruction packets; and
a processing unit configured to execute said instruction packets sequentially in a pipeline manner,
wherein said processing unit comprises:
an instruction queue, wherein said instruction packets stored in said instruction queue are executed sequentially by said processing unit; and
a loop speed-up circuit configured to store said instruction packets read out from said instruction memory into said instruction queue sequentially, to hold the instruction packet containing a loop start address for a loop process, and to output the held instruction packet to said instruction queue, when a loop process end is detected and said loop process is not circulated for a predetermined number of times.

2. The data processing apparatus according to claim 1, wherein said loop speed-up circuit comprises:
a loop instruction queue group;
a loop queue flag configured to indicate whether said loop queue flag is valid or invalid; and
a selector,
wherein said processing unit
determines whether the instruction packet to be executed is a loop start instruction for said loop process,
copies the instruction packet containing said loop start address from said instruction queue into said loop instruction queue group when determining that said instruction packet to be executed is said loop start instruction, and
sets said loop queue flag to a valid state.

3. The data processing apparatus according to claim 2, wherein said processing unit controls said selector to select and output said instruction packet stored in said loop instruction queue group to said instruction queue, when said loop process end is detected and said loop process is not circulated for a predetermined number of times.

4. The data processing apparatus according to claim 2, wherein said processing unit controls said selector to select and output said instruction packet read from said instruction memory to said instruction queue, when said loop process end is not detected or said loop process is circulated for a predetermined number of times.

5. The data processing apparatus according to claim 2, wherein said processing unit controls said selector to select and output said instruction packet read from said instruction memory to said instruction queue, when said instruction packet to be executed is an instruction packet for looping out from said loop process.

6. The data processing apparatus according to claim 2, wherein said processing unit sets said loop queue flag to an invalid state, when said instruction packet to be executed is an instruction packet for looping out from said loop process or said loop process is circulated for a predetermined number of times.

7. The data processing apparatus according to claim 6, wherein said processing unit controls said selector to select and output said instruction packet read from said instruction memory to said instruction queue, when said loop queue flag is in said invalid stage, and controls said selector to select and output said instruction packet stored in said loop instruction queue group to said instruction queue, when said loop process end is detected, said loop process is not circulated for a predetermined number of times, and said loop queue flag is in said valid stage.

8. The data processing apparatus according to claim 2, wherein said loop instruction queue group includes loop instruction queues of a number less by one than a number of stages necessary to read said instruction packet from said instruction memory into said instruction queue.

9. The data processing apparatus according to claim 8, wherein said processing unit controls said selector to select and output said stored instruction packet from each of said loop instruction queues of said loop instruction queue group to said instruction queue sequentially.

10. A data processing method using a pipeline processing system, comprising:
reading instruction packets from an instruction memory into instruction queue through a selector sequentially;
determining whether the instruction packet to be executed is a loop start instruction for a loop process;
copying the instruction packet containing a loop start address from said instruction queue into said loop instruction queue when determining that said instruction packet to be executed is said loop start instruction;
setting said loop queue flag to a valid state; and
executing the instruction packets stored in said instruction queue sequentially.

11. The data processing method according to claim 10, further comprising:
determining whether the instruction packet to be executed is an instruction packet for looping out;
setting said loop queue flag to an invalid state, when determining that the instruction packet is the instruction packet for the looping out; and
carrying out the read of the instruction packet from the instruction memory into the instruction queue.

12. The data processing method according to claim 11, further comprising:
determining whether said loop process reaches a loop end, when determining that the instruction packet is not the instruction packet for the looping out; and
carrying out the read of the instruction packet from the instruction memory into the instruction queue, when determining that said loop process does not reach the loop end.

13. The data processing method according to claim 12, further comprising:
determining whether said loop process is circulated for a predetermined number of times by the loop start instruction, when determining that the loop process reaches the loop end;
setting said loop queue flag to said invalid state, when determining that the loop process is circulated for the predetermined number of times; and
carrying out the read of the instruction packet from the instruction memory into the instruction queue.

14. The data processing method according to claim 13, further comprising:
checking whether the loop queue flag is in the valid state, when determining that the loop process is circulated for the predetermined number of times; and
carrying out the read of the instruction packet from said instruction memory into said instruction queue, when determining said loop queue flag is not in the valid state.

15. The data processing method according to claim 14, further comprising:
reading the instruction packet stored into said loop instruction queue when determining that the loop queue flag is in the valid state.

16. The data processing method according to claim 10, wherein said loop instruction queue group includes loop instruction queues of a number less by one than a number of stages necessary to read said instruction packet from said instruction memory into said instruction queue.
